(19) United States
(12) Patent Application Publication
(10) Pub. No.: US 2025/0229683 A1
(43) Pub. Date: Jul. 17, 2025

(54) FIXING STRUCTURE FOR SEAT CUSHION TRIM COVER AND VEHICLE SEAT INCLUDING THE SAME

(71) Applicant: TACHI-S CO., LTD., Tokyo (JP)

(72) Inventors: Takashi SHINDO, Tokyo (JP); Hiroyoshi WADA, Tokyo (JP); Ryouta TOMIOKA, Tokyo (JP)

(73) Assignee: TACHI-S CO., LTD., Tokyo (JP)

(21) Appl. No.: 19/008,504

(22) Filed: Jan. 2, 2025

(30) Foreign Application Priority Data
Jan. 16, 2024 (JP) 2024-004440

(51) Int. Cl. B60N 2/72

(52) U.S. Cl. CPC B60N 2/72

(57) ABSTRACT

A structure for firmly fixing individual attachment members to each other when a trim cover is attached to a seat cushion is simplified to be able to contribute to a cost reduction. A fixing structure for a trim cover in a vehicle seat includes a belt-like member protruding from the trim cover, an engagement portion provided in a portion of the trim cover other than the belt-like member, an insertion portion provided in either one of an end portion of the belt-like member and the engagement portion, and an insertion hole provided in another of the end portion of the belt-like member and the engagement portion to allow the insertion portion to be inserted therein and maintain a state where the insertion portion is inserted therein, thereby achieving a state where the vehicle seat is covered with the trim cover to be fixed.

### BACKGROUND

### Field

The present invention relates to a fixing structure for a seat cushion trim cover and a vehicle seat including the same.

### Description of Related Art

Conventionally, a vehicle seat in which a seat cushion is covered with a trim cover serving as a skin material has been used. The trim cover covering the seat cushion is brought into an attached state by, e.g., engaging two individual attachment members protruding from the trim cover with each other on a back surface side of the seat cushion (see, e.g., Patent Publication JP-A-2020-138555). When the individual attachment members are firmly fixed to each other on the back surface side of the seat cushion, a means such as bonding the two attachment members together or using a hook-and-loop fastener is used.

### SUMMARY

However, a structure in which individual attachment members are bonded together or firmly fixed to each other by using a hook-and-loop fastener is such that a member for firm fixation (such as an adhesive material or a hook-and-loop fastener) is additionally provided, which may not only increase cost, but also need considerable time and labor for manufacturing. For example, when individual attachment members are to be bonded and fixed to each other with an adhesive material, while tension acts on the attachment members to move the attachment members away from each other, the both attachment members need to be held together with something until the attachment members are completely bonded together, which may require time and labor.

It is therefore an object of the present invention to provide a fixing structure for a seat cushion trim cover in which a structure for firmly fixing attachment members to each other when a trim cover is attached to a seat cushion is simplified to be able to contribute to a cost reduction and a vehicle seat including the same.

An aspect of the present invention is a fixing structure for a trim cover in a vehicle seat, the fixing structure including: a belt-like member protruding from the trim cover; an engagement portion provided in a portion of the trim cover other than the belt-like member; an insertion portion provided in either one of an end portion of the belt-like member and the engagement portion; and an insertion hole provided in another of the end portion of the belt-like member and the engagement portion to allow the insertion portion to be inserted therein and maintain a state where the insertion portion is inserted therein, the fixing structure achieving a state where the vehicle seat is covered with the trim cover to be fixed.

With the fixing structure described above, by merely inserting and engaging the insertion portion of the belt-like member in and with the insertion hole of the engagement portion, it is possible to bring the belt-like member and the engagement portion into a firmly fixed state. Such a structure simplifies work by eliminating the need to bond the belt-like member and the engagement portion together, and can eliminate another member (such as an adhesive material or a hook-and-loop fastener) for firmly fixing the belt-like member and the engagement portion to each other. The elimination of the other member can contribute to a resulting cost reduction and also simplifies the structure.

In the fixing structure for the trim cover in the vehicle seat described above, the insertion portion may be formed in a shape protruding in a width direction of the belt-like member or the engagement portion.

In the fixing structure for the trim cover in the vehicle seat described above, the insertion portion may have a substantially rectangular shape.

In the fixing structure for the trim cover in the vehicle seat described above, the insertion portion may have at least a portion thereof which is folded back and superimposed.

In the fixing structure for the trim cover in the vehicle seat described above, the insertion portion may include a rigid material which increases a rigidity of the insertion portion.

In the fixing structure for the trim cover in the vehicle seat described above, the rigid material may be any one of a sewing thread, a welding material, an adhesive material, and nonwoven fabric.

In the fixing structure for the trim cover in the vehicle seat described above, the belt-like member may have at least a portion thereof formed in a tapered shape having a width which decreases with increasing distance from the insertion portion.

In the fixing structure for the trim cover in the vehicle seat described above, the belt-like member may have at least a portion thereof formed in a tapered shape having a width which increases with increasing distance from the insertion portion.

In the fixing structure for the trim cover in the vehicle seat described above, the insertion hole may have a slit shape.

In the fixing structure for the trim cover in the vehicle seat described above, the insertion hole may be formed so as to extend along a longitudinal direction of the belt-like member in the state where the insertion portion is inserted in the insertion hole.

In the fixing structure for the trim cover in the vehicle seat described above, the insertion hole may have a metallic eyelet portion provided in at least one end thereof.

In the fixing structure for the trim cover in the vehicle seat described above, the insertion hole of the engagement portion may have a substantially circular or ellipsoidal shape.

In the fixing structure for the trim cover in the vehicle seat described above, the insertion hole of the engagement portion may have a substantially rectangular shape.

In the fixing structure for the trim cover in the vehicle seat described above, an outer periphery of the insertion hole may have a reinforcing seam.

Another aspect of the present invention is a vehicle seat including the fixing structure described above.

In the vehicle seat described above, the fixing structure may also be applied to a seat cushion.

According to the present invention, it is possible to provide a fixing structure for a seat cushion trim cover in which a structure for firmly fixing individual attachment members to each other when a trim cover is attached to a seat cushion is simplified to be able to contribute to a cost reduction and a vehicle seat including the same.

### BRIEF DESCRIPTION OF DRAWINGS

FIG. 1 is a perspective view illustrating an example of a vehicle seat;

FIG. 2 illustrates an image showing a back surface side of a seat cushion;

FIG. 3 illustrates an image enlargedly showing a portion denoted by a reference sign A in FIG. 2;

FIG. 4 illustrates an image showing a state where an insertion portion of a belt-like member is detached from an insertion hole of an engagement portion;

FIG. 5 illustrates an image enlargedly showing a portion denoted by a reference sign B in FIG. 2;

FIG. 6A and FIG. 6B illustrate images showing a process in which the insertion portion of the belt-like member is inserted from inside the insertion hole of the engagement portion until the insertion portion is engaged with the insertion hole;

FIG. 7A and FIG. 7B illustrate images showing a process in which the insertion portion of the belt-like member is inserted from outside the insertion hole of the engagement portion until the insertion portion is engaged with the insertion hole;

FIG. 8A to FIG. 8D are diagrams illustrating examples of a configuration of the insertion portion of the belt-like member to be inserted and engaged in and with the insertion hole of the engagement portion;

FIG. 9A to FIG. 9C are diagrams illustrating examples of a configuration of the belt-like member; and

FIG. 10A to FIG. 10I are diagrams illustrating examples of a configuration of the insertion hole of the engagement portion.

### DETAILED DESCRIPTION

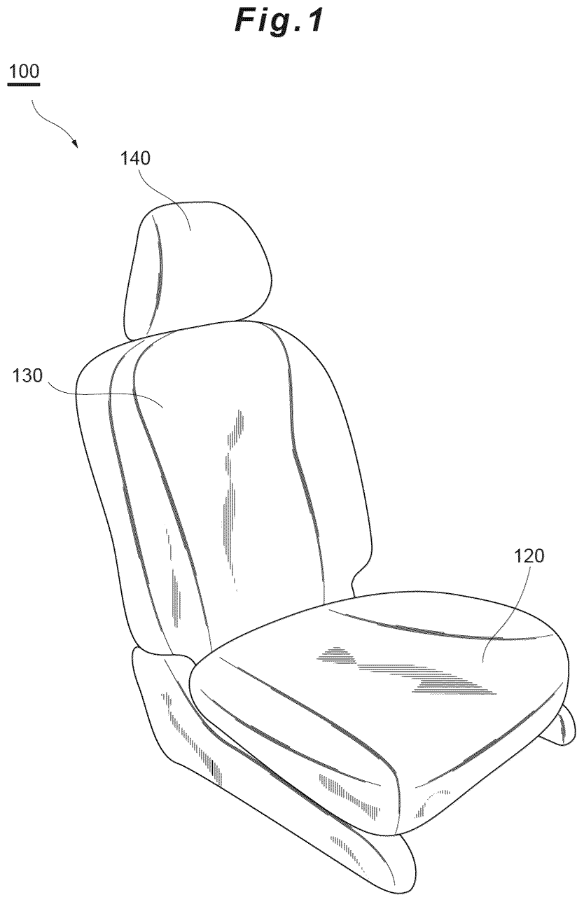

Referring to the drawings, a detailed description will be given of a preferred embodiment of the present invention (see FIG. 1 to FIG. 10I).

### Vehicle Seat

A vehicle seat 100 is a seat to be placed in a vehicle such as, e.g., an automobile and includes a seat cushion 120 that supports buttocks and thighs of a seated occupant, a seat back 130 that supports a lower back region and a back region of the occupant, and a head rest 140 that supports a head region of the occupant (see FIG. 1). In each of the seat cushion 120 and the seat back 130, a seat frame (not shown) forming a framework of the seat cushion 120 or the seat back 130 is embedded. Such a seat frame is covered with a seat pad 104 made of a relatively soft resin foam material such as urethane foam and is further covered with a trim cover 110 made of a skin material such as leather, woven fabric, or unwoven fabric.

### Fixing Structure 10 for Trim Cover 110

A fixing structure 10 for the trim cover 110 in the vehicle seat 100 according to the present invention is a structure for fixing the trim cover 110 to the vehicle seat 100. The following will describe the fixing structure 10 for the trim cover 110 in the seat cushion 120, while giving examples thereof and, needless to say, the fixing structure 10 for the trim cover 110 in the seat cushion 120 is also applicable to the fixing structure 10 for the trim cover 110 in the seat back 130.

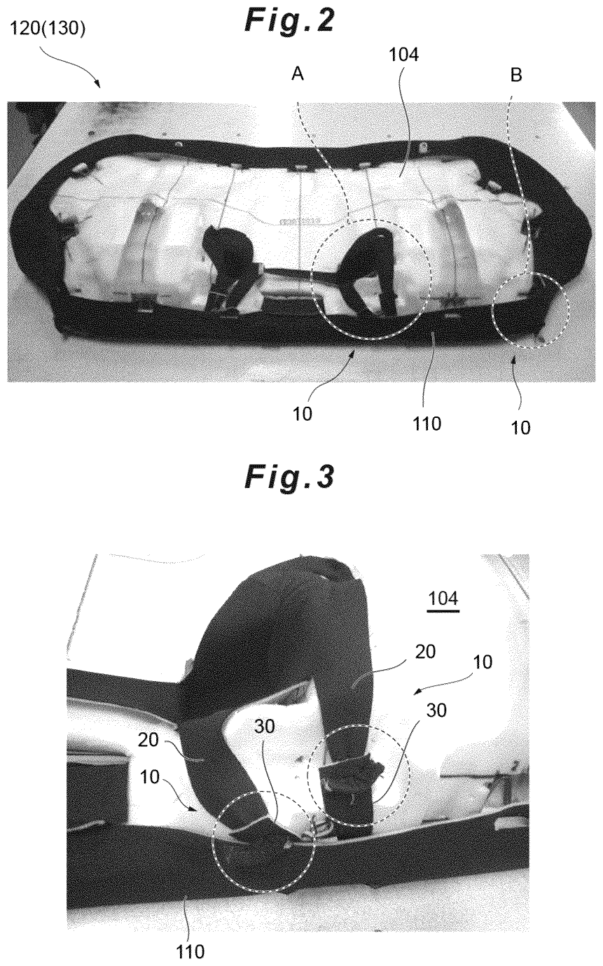

The fixing structure 10 for the trim cover 110 in the present embodiment is configured as a structure for achieving a state where the seat cushion 120 of the vehicle seat 100 is covered with the trim cover 110 by using a belt-like member 20, an insertion portion 22, an engagement portion 30, an insertion hole 32, and the like to be fixed (see FIG. 2 to FIG. 10I).

### Belt-Like Member

The belt-like member 20 is a member provided so as to protrude from a portion of the trim cover 110 to extend. Meanwhile, the engagement portion 30 is a member provided in a portion of the trim cover 110 other than the belt-like member 20. These belt-like member 20 and engagement portion 30 are provided so as to allow the trim cover 110 to be fixed at a predetermined position on the seat cushion 120 by causing a portion of the belt-like member 20, e.g., an end portion 21 to be engaged with the engagement portion 30. As long as the belt-like member 20 and the engagement portion 30 are thus provided, the numbers of the belt-like members 20 and the engagement portions 30 and placement thereof are not particularly limited, and may also be the same as those in a previous structure. The present embodiment shows an example (see FIG. 2 to FIG. 4) in which two branched portions into which the belt-like member 20 is divided in the middle are respectively engaged with the two adjacent engagement portions 30 and an example (see FIG. 2 and FIG. 5) in which the belt-like member 20 and the engagement portion 30 are provided in the vicinity of a corner portion (corner) of the seat cushion 120.

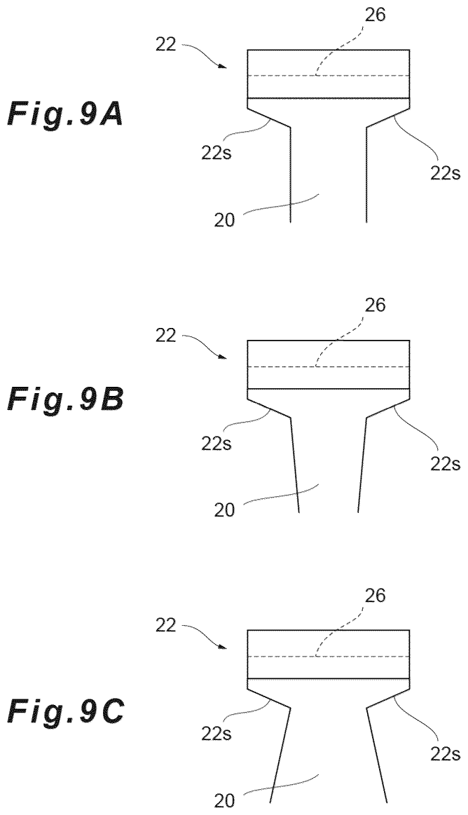

A shape or the like of the belt-like member 20 is not particularly limited. For example, the belt-like member 20 may be formed in a straight shape having a constant width (see FIG. 9A) or may also be formed in a tapered shape (narrowed bottom shape) having a width which decreases with increasing distance from the insertion portion 22 (see FIG. 9B) or, alternatively, at least a portion of the belt-like member 20 may also be formed in a tapered shape (widened bottom shape) having a width which increases with increasing distance from the insertion portion 22 (see FIG. 9C).

### Insertion Portion

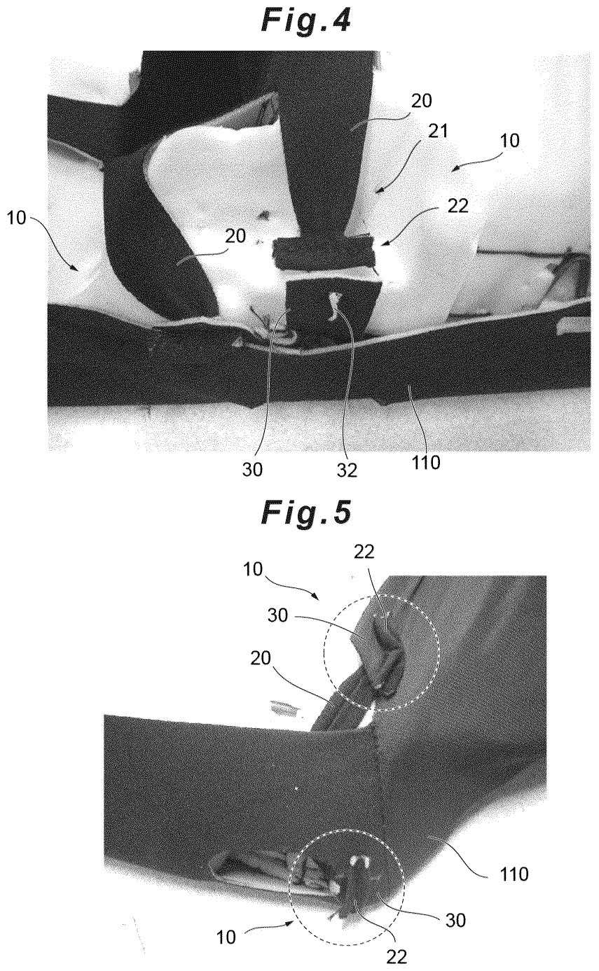

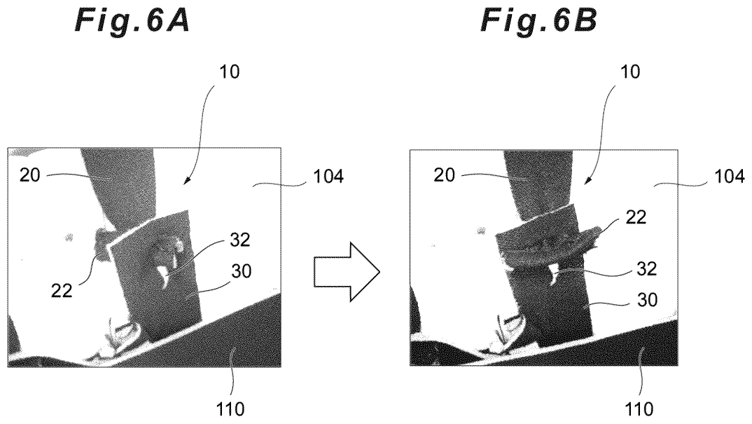

The insertion portion 22 is a portion to be inserted into the insertion hole 32 of the engagement portion 30, and is provided in the end portion 21 of the belt-like member 20 (see FIG. 4). The insertion hole 32 is provided in the engagement portion 30 so as to allow the insertion portion 22 to be inserted therein and maintain a state where the insertion portion 22 is inserted therein. The present embodiment simplifies, for these insertion portion 22 and insertion hole 32, a structure for firmly fixing the individual members to each other to be able to also contribute to a cost reduction. The following will give a description, while giving specific examples (see FIG. 6A to FIG. 10I and the like).

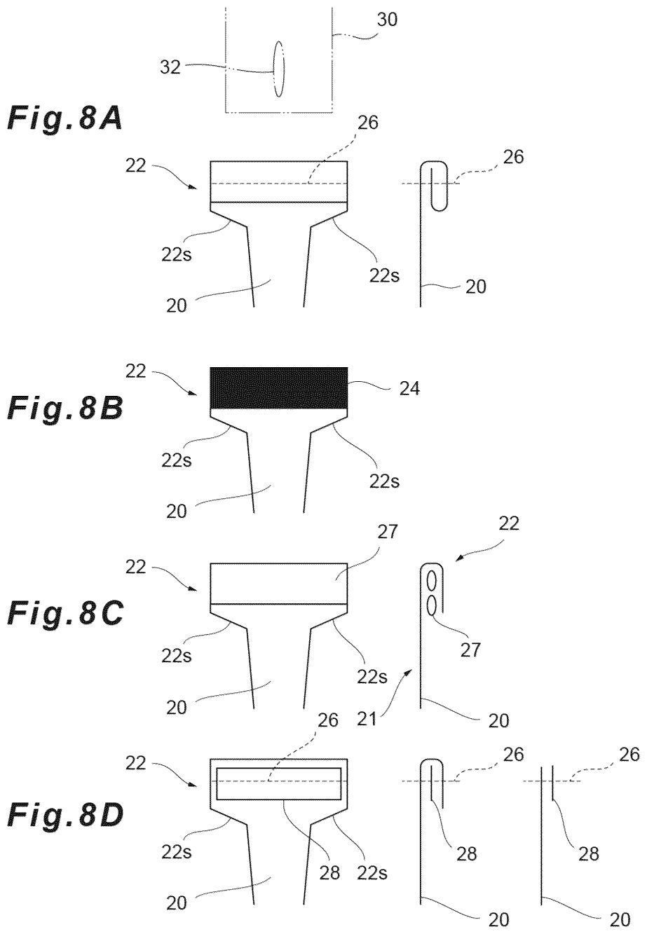

The insertion portion 22 is formed in a shape protruding in a width direction of the belt-like member 20 or the engagement portion 30 (see FIG. 8A to FIG. 8D and FIG. 9A to FIG. 9C). By forming the insertion portion 22 in a so-called letter-T shape, it is possible to engage the insertion portion 22 after being inserted into the insertion hole 32 such that the insertion portion 22 does not come out of the insertion hole 32 (see FIG. 3, FIG. 5, and the like). Note that a specific shape of the insertion portion 22 is not particularly limited. The insertion portion 22 may also have a shape with an inclined portion 22s in which, e.g., a length (height) of the belt-like member 20 along a longitudinal direction gradually decreases with increasing distance from the belt-like member 20 along the width direction of the belt-like member 20 (see FIG. 8A to FIG. 8D and FIG. 9A to FIG. 9C) or may also have a substantially rectangular shape.

The insertion portion 22 may also be configured such that at least a portion thereof is thicker. The insertion portion 22 having the thicker portion is accordingly less likely to come out of the insertion hole 32, and consequently even a simple structure allows easier maintenance of a state where the belt-like member 20 and the engagement portion 30 are firmly engaged with each other. Examples of such a structure include a configuration in which the insertion portion 22 is partly folded back and sewed with a sewing thread (or suture) 26 to have a rigidity and include a superimposed portion (see FIG. 8A), a structure obtained by performing welder processing (processing of firmly fixing a welding material 24 such as a molten solder as a rigid material) on at least a portion of the insertion portion 22 to give a rigidity thereto (see FIG. 8B), a configuration in which the insertion portion 22 is partly folded back and bonded with an adhesive material 27 to include a superimposed portion (see FIG. 8C), and a structure obtained by firmly fixing a rigid material such as unwoven fabric (felt material) 28 to the insertion portion 22 by sewing using the sewing thread 26 or the like or by partly folding back the insertion portion 22 to hold the unwoven fabric 28 or the like in between and firmly fixing the unwoven fabric 28 thereto by sewing or the like (see FIG. 8D). Any of the structures shown by way of example allows the individual members to be reliably engaged with each other, while having a relatively simple and simplified configuration.

### Insertion Hole

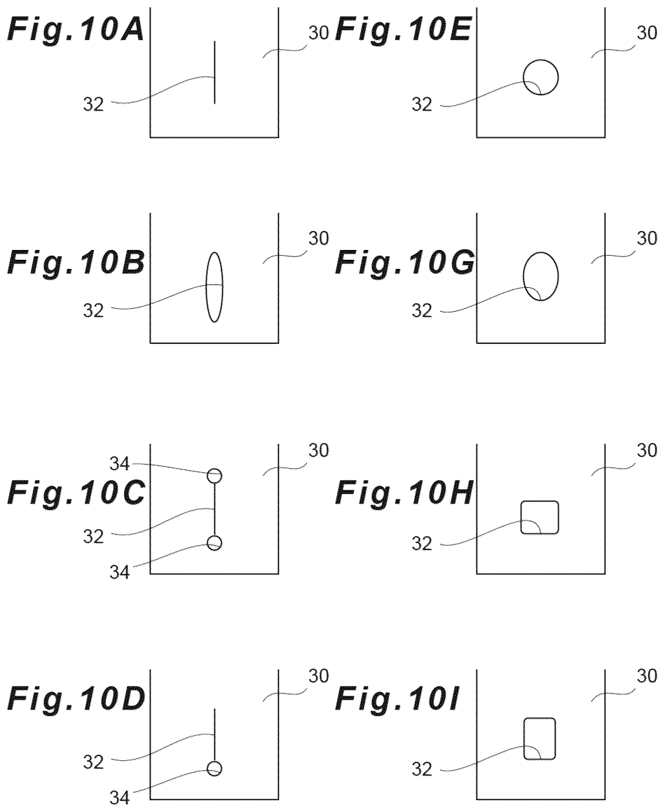

The insertion hole 32 is provided in the engagement portion 30 so as to allow the insertion portion 22 to be inserted therein and be able to maintain the state where the insertion portion 22 is inserted therein. As long as the insertion hole 32 is thus provided, a specific shape or structure of the insertion hole 32 is not particularly limited. For example, the insertion hole 32 may also have a thin slit shape (see FIG. 10A) or a slit shape like an ellipsoidal shape (see FIG. 10B). In at least one end (e.g., one end on a side where the belt-like member 20 is located) or each of both ends, a metallic eyelet portion 34 may also be provided so as to inhibit the end portion from being cut or torn (see FIG. 10C and FIG. 10D). Each of the examples of the insertion hole 32 shown herein is formed so as to extend along the longitudinal direction of the belt-like member 20 in the state where the insertion portion 22 is inserted in the insertion hole 32 (see FIG. 10A to FIG. 10D), but the insertion hole 32 may also be formed so as to extend along a different direction (e.g., the width direction of the belt-like member 20), though not particularly shown.

In another example, the insertion hole 32 of the engagement portion 30 may also have a substantially circular or ellipsoidal shape (see FIG. 10E and FIG. 10G) or a substantially rectangular shape (e.g., a substantially square or rectangular shape (see FIG. 10H and FIG. 10I). Alternatively, it may also be possible to provide an outer periphery of the insertion hole 32 with a reinforcing seam to be able to inhibit the cutting and tearing.

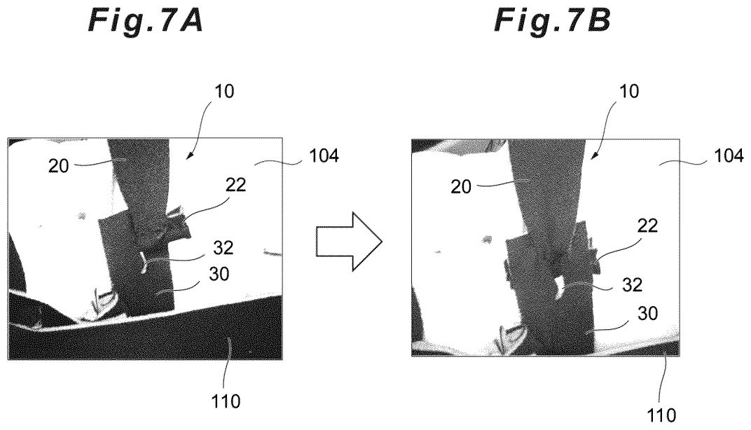

With the fixing structure 10 for the trim cover 100 described above, by merely inserting and engaging the insertion portion 22 of the belt-like member 20 in and with the insertion hole 32 of the engagement portion 30, it is possible to bring the belt-like member 20 and the engagement portion 30 into a firmly fixed state. At this time, the insertion portion 22 may be inserted from a surface side of the engagement portion 30 (see FIG. 7A and FIG. 7B) or, conversely, the insertion portion 22 may also be inserted from a back side of the engagement portion 30 (see FIG. 6A and FIG. 6B). Additionally, as has been described heretofore, the fixing structure 10 in the present embodiment simplifies work by eliminating the need to bond the belt-like member 20 and the engagement portion 30 together, and can eliminate another member (such as an adhesive material or a hook-and-loop fastener) for firmly fixing the belt-like member 20 and the engagement portion 30 to each other. By thus eliminating the other member, a resulting cost reduction as well as a simplified structure is achieved.

Note that the embodiment described above is an example of the preferred embodiment of the present invention, but is not limited thereto and can variously be modified and implemented within a scope not departing from the gist of the present invention. For example, in the embodiment described above, a mode in which the end portion 21 of the belt-like member 20 is provided with the insertion portion 22 and the engagement portion 30 is provided with the insertion hole 32 has been described, but this is only a preferred example. Conversely, it may also be possible to adopt a mode in which the end portion 21 of the belt-like member 20 is provided with an insertion hole and the engagement portion 30 is provided with an insertion portion.

The present invention is appropriately applied to a fixing structure for a seat cushion trim cover and a vehicle seat including the same.

What is claimed is:

1. A fixing structure for a trim cover in a vehicle seat, the fixing structure comprising:
a belt-like member protruding from the trim cover;
an engagement portion provided in a portion of the trim cover other than the belt-like member;
an insertion portion provided in either one of an end portion of the belt-like member and the engagement portion; and
an insertion hole provided in another of the end portion of the belt-like member and the engagement portion to allow the insertion portion to be inserted therein and maintain a state where the insertion portion is inserted therein,
the fixing structure achieving a state where the vehicle seat is covered with the trim cover to be fixed.

2. The fixing structure for the trim cover in the vehicle seat according to claim 1, wherein the insertion portion is formed in a shape protruding in a width direction of the belt-like member or the engagement portion.

3. The fixing structure for the trim cover in the vehicle seat according to claim 2, wherein the insertion portion has a substantially rectangular shape.

4. The fixing structure for the trim cover in the vehicle seat according to claim 2, wherein the insertion portion has at least a portion thereof which is folded back and superimposed.

5. The fixing structure for the trim cover in the vehicle seat according to claim 2, wherein the insertion portion includes a rigid material which increases a rigidity of the insertion portion.

6. The fixing structure for the trim cover in the vehicle seat according to claim 5, wherein the rigid material is any one of a sewing thread, a welding material, an adhesive material, and nonwoven fabric.

7. The fixing structure for the trim cover in the vehicle seat according to claim 1, wherein the belt-like member has at least a portion thereof formed in a tapered shape having a width which decreases with increasing distance from the insertion portion.

8. The fixing structure for the trim cover in the vehicle seat according to claim 1, wherein the belt-like member has at least a portion thereof formed in a tapered shape having a width which increases with increasing distance from the insertion portion.

9. The fixing structure for the trim cover in the vehicle seat according to claim 1, wherein the insertion hole has a slit shape.

10. The fixing structure for the trim cover in the vehicle seat according to claim 9, wherein the insertion hole is formed so as to extend along a longitudinal direction of the belt-like member in the state where the insertion portion is inserted in the insertion hole.

11. The fixing structure for the trim cover in the vehicle seat according to claim 10, wherein the insertion hole has a metallic eyelet portion provided in at least one end thereof.

12. The fixing structure for the trim cover in the vehicle seat according to claim 1, wherein the insertion hole of the engagement portion has a substantially circular or ellipsoidal shape.

13. The fixing structure for the trim cover in the vehicle seat according to claim 1, wherein the insertion hole of the engagement portion has a substantially rectangular shape.

14. The fixing structure for the trim cover in the vehicle seat according to claim 1, wherein an outer periphery of the insertion hole has a reinforcing seam.

15. A vehicle seat comprising the fixing structure according to claim 1.

16. The vehicle seat according to claim 15, wherein the fixing structure is applied to a seat cushion.
